(19) United States
(12) Patent Application Publication
(10) Pub. No.: US 2009/0200403 A1
(43) Pub. Date: Aug. 13, 2009

(54) FUEL INJECTOR

(76) Inventors: David Ling-Shun Hung, Novi, MI (US); Vivek A. Jairazbhoy, Farmington Hills, MI (US); David L. Porter, Westland, MI (US)

Correspondence Address: DICKINSON WRIGHT PLLC, 1875 Eye Street, NW, Suite 1200, WASHINGTON, DC, 20006, US

(21) Appl. No.: 12/028,340

(22) Filed: Feb. 8, 2008

(51) Int. Cl. F02M 61/04

(52) U.S. Cl. 239/533.12

(57) ABSTRACT

A fuel injector having a nozzle with depressions for increasing fluid turbulence and preventing deposit build up within the injector to increase performance, longevity and fuel economy.

### CROSS REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Technical Field

The present invention is related to fuel injectors for automotive engines and, more particularly, to fuel injector nozzles capable of maintaining performance in harsh engine operating conditions.

2. Discussion

Fuel injected internal combustion engines are well known in the industry. In direct injected engines, the injection tip of the fuel injector extends into the combustion chamber. The fuel may also be injected into the cylinder through port injection with the injector being located within the intake port. If the fuel is port injected, the fuel is first mixed with air before being drawn into the cylinder. Each fuel injector includes a perforated plate, also known as a metering plate, for dispersing and directing fuel into the cylinder.

The metering plate is located on the end of the fuel injector, and particularly on the nozzle, and includes a variety of fuel flow passages that are configured to atomize the fuel into extremely small fuel droplets to meet stringent emission standards for internal combustion engines. The fine atomization of the fuel reduces exhaust emissions, improves cold weather start capabilities, reduces fuel consumption, and improves performance. Typically the optimization of the droplet size depends on the pressure of the fuel and requires high pressure delivery of roughly 7 to 10 MPa. However, such high fuel delivery pressures may cause greater dissipation of the fuel and propagate the fuel further outward from the injector, thereby making it more likely that fuel condenses on the walls of the cylinder and on the top surface of the piston or on the walls of the intake port instead of remaining atomized in the air. Any condensation on the walls or piston significantly decreases the efficiency of the combustion, thereby increasing emissions and decreasing performance of the engine.

To address these problems, some manufactures utilize a low pressure fuel injection system which is still capable of sufficiently atomizing the fuel. To generate sufficient atomization at low pressure, fuel injectors typically employ sharp edges in the nozzle orifice for atomization and acceleration of the fuel. However, the relatively low pressure of the fuel and sharp edges result in the spray being difficult to direct and reduces the range of the spray. More particularly, the spray angle or cone angle produced by the injector is somewhat narrow. To tune the spray angle and to provide sufficient atomization, typically the fuel flow passages in the metering plate are located some distance from the longitudinal axis of the nozzle. Therefore, the fuel flows through a passage in the injector and outward along the dispersion side of the nozzle through an orifice cavity defined by the dispersion end of the nozzle and the metering plate. In particular to direct injected engines, the fuel injectors may experience build-up on the dispersion end of the nozzle and in particular on the dispersion end behind each of the fuel exit cavities or orifices in the metering plate. This build-up on the dispersion end of the nozzle may interfere with fuel delivery, interfere with the atomization of the fuel, and interfere with the spray angle, all of which may increase emissions and fuel consumption and decrease engine performance. Therefore it would be desirable to develop fuel injectors, whether low pressure fuel injectors or high pressure fuel injectors, that limit the effect of any build-up and improve the performance of the fuel injectors.

### SUMMARY OF THE INVENTION

In view of the above, the present invention is directed to a fuel injector including a nozzle having a longitudinal axis and a valve passage extending along the longitudinal axis. The nozzle also includes a dispersion end configured to receive a metering plate. The metering plate is in fluid communication with the passage extending through the nozzle. The fuel flows through the passage and along the dispersion end through an outlet cavity defined by the dispersion end and metering plate and then out the exit cavity on the metering plate. The dispersion end includes at least one depression arranged behind an exit cavity on the metering plate. The depression allows contaminants and impurities to build-up on the dispersion end without affecting the flow of the fuel through the exit cavities and, more particularly, without affecting the atomization or spray angle of the fuel.

The depression may have any size, shape, or configuration so long as it does not detract from the performance of the fuel injector while yet providing a place for build-up to occur thereby increasing the longevity of the fuel injector. The depression may be formed in elliptical or circular shapes and in some embodiments is formed in a radial shape extending in a circular pattern about the longitudinal axis. In some embodiments, the depression may be formed with sharp edges to increase the fluid turbulence of the fuel and thereby improve atomization.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a top plan view of exemplary metering plate;

FIG. 2 is a plan view of an exemplary dispersion end of the nozzle;

FIG. 3 is a plan view of the dispersion end of FIG. 2, with the metering plate of FIG. 1 superimposed and portions of the dispersion end shown in phantom;

FIG. 4 is a sectional view of the nozzle in FIG. 3 along lines 4-4;

FIG. 5 is a plan view of an exemplary dispersion end;

FIG. 6 is a plan view of an exemplary metering plate;

FIG. 7 is a plan view of the dispersion end of FIG. 5 with the metering plate of FIG. 6 superimposed in phantom; and

FIG. 8 is a plan view of an exemplary nozzle on the dispersion end with an exemplary metering plate superimposed in phantom.

### DETAILED DESCRIPTION OF THE PREFERRED EMBODIMENT

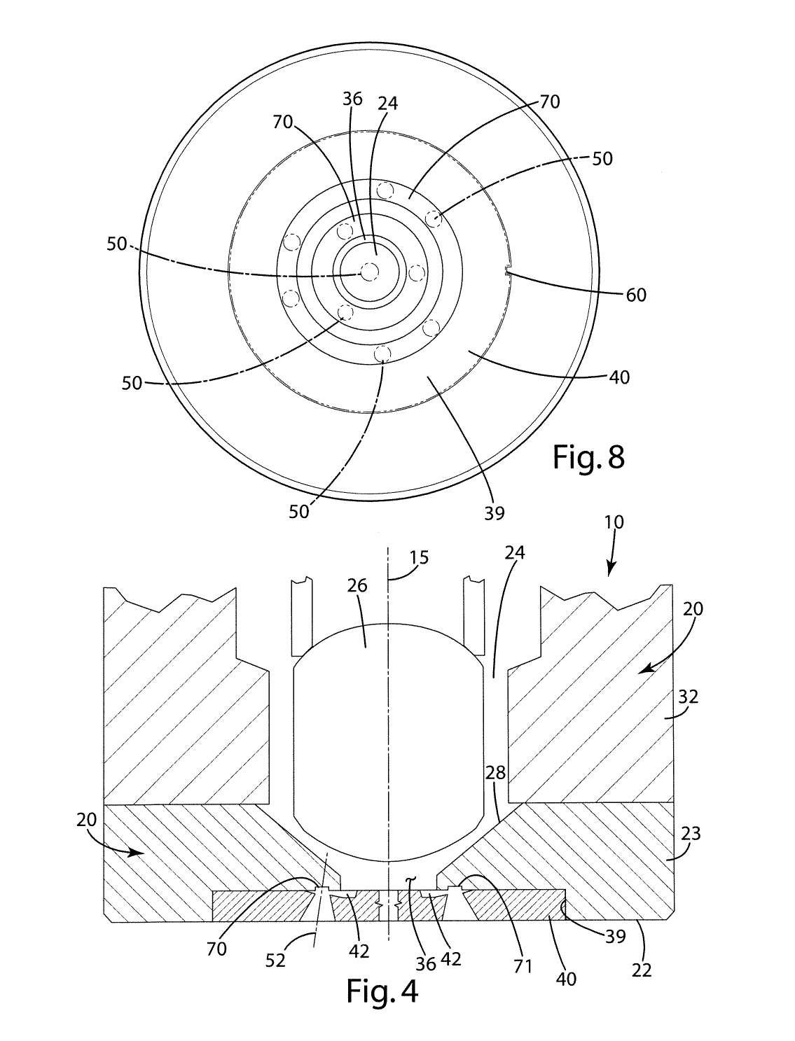

A fuel injector nozzle 20 is generally illustrated in partial cross-sectional view in FIG. 4. The nozzle 20 is formed at a lower end of a fuel injector, which is used to deliver fuel to a cylinder of an engine, such as an internal combustion engine of an automobile. The nozzle 20 defines a passageway 24 through which the fuel passes toward the dispersion end 22. Although the fuel injector 10 may be formed of a variety of configurations, the nozzle 20 generally includes a needle valve 26 located within the passageway 24 and capable of engaging a valve seat 28. The needle 26 and valve seat 28 cooperate to form a needle valve to start and stop fluid flow through the nozzle 20. The nozzle 20 is generally aligned along a longitudinal axis 15 and the passageway 24 generally extends along or parallel to the longitudinal axis 15. A lower end of the injector body or dispersion end 22 defines the valve outlet 36. As illustrated in FIG. 4, the nozzle 20 may be formed from a nozzle body 32 and an injector body 23. It should be recognized by those skilled in the art that the injector body 23 and nozzle body 32 may be separately formed and attached by welding or other known techniques.

In either case, the nozzle 20 generally defines the valve seat 28 and the valve outlet 36. The needle 26 is generally moved along the longitudinal axis 15, in and out of engagement with the valve seat 28, and is usually controlled by an electromagnetic actuator (not shown). In this manner, fluid or fuel flowing through the internal passageway 24 and around the needle 26 is permitted or prevented from flowing to the valve outlet 36 by the engagement or disengagement of the needle 26 with the valve seat 28.

The nozzle 20 further includes a metering plate 40 which is coupled to the nozzle at the dispersion end 22. It will be recognized by those skilled in the art that the metering plate 40 may be integrally formed with the nozzle body or may be separately formed and attached as illustrated in FIG. 4 by welding or other known techniques. In either case, the metering plate defines an orifice cavity 42 (FIG. 4). The orifice cavity 42 may be generally defined by both the metering plate 40 and the lower portion, specifically the dispersion end 22, of the nozzle. As illustrated further in FIG. 4, the metering plate also may define portions of the orifice cavity 42. The orifice cavity 42 defined by the metering plate is defined by a bottom wall, a side wall, as well as a center wall as illustrated in FIG. 4, however, the metering plate used may be of any exemplary size, shape, and configuration thereby varying the configuration of the orifice cavity.

The metering plate 40 may include an outer rim which may be at least partially recessed into the recessed area 39 defined by the nozzle 20 and specifically the dispersion end 22. While the metering plate 40 is illustrated in the figures as being round, other shapes and configurations may be used, however a round metering plate 40 is easier to assemble as they are generally unidirectional. However, if the spray pattern produced by the metering plate 40 is directional or desirable to be keyed in a certain direction, the metering plate may be formed in other shapes and configurations to allow easy assembly of the metering plate 40 to the nozzle 20 with the desired directional spray pattern. As illustrated in FIG. 8, the metering plate and nozzle 20 may include a keyed mechanism 60 to align a round metering plate.

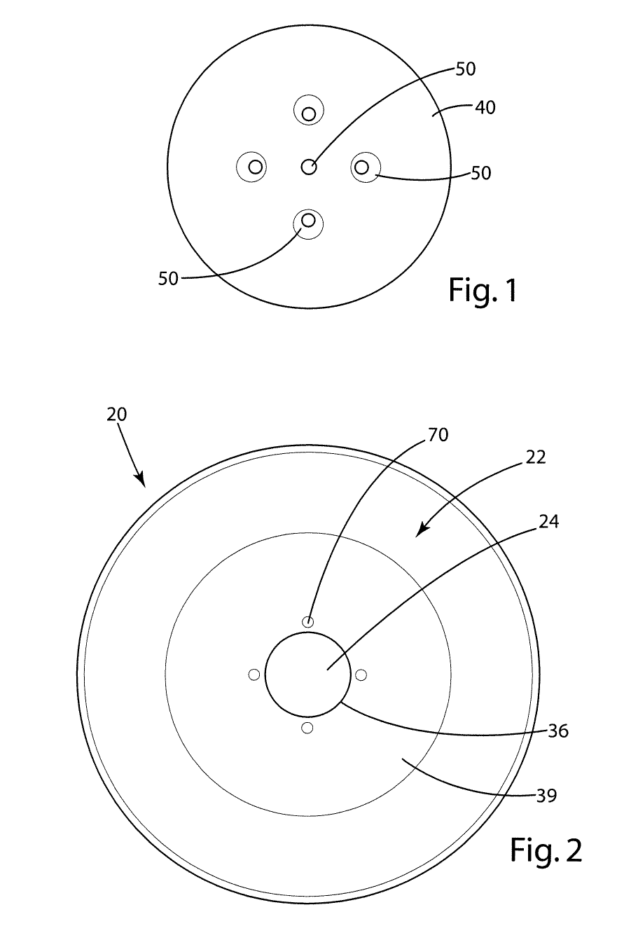

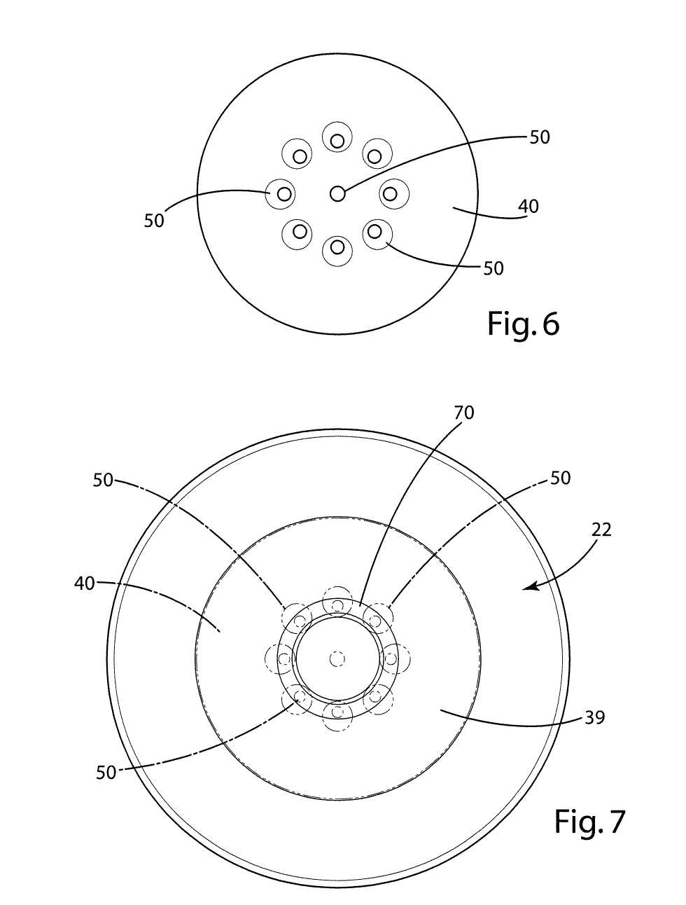

The metering plate 40 generally includes at least one exit cavity 50. The exit cavities may be configured in a wide variety of shapes, sizes, and geometrical configurations such as illustrated in FIGS. 1-3 and 5-8. In some embodiments, only a couple of exit cavities are needed such as illustrated in FIG. 1. In other embodiments, the metering plate may include a multitude of exit cavities in a ring about a center exit cavity, as illustrated in FIG. 6, and further may include, as illustrated in FIG. 8, an outer ring and inner ring centered about a center exit cavity. Of course, the exit cavities may vary in number, size, shape, and configuration and although the metering plate is shown in all of the figures as having a center exit cavity, this is not required as the location of the exit cavities on the metering plate are only exemplary.

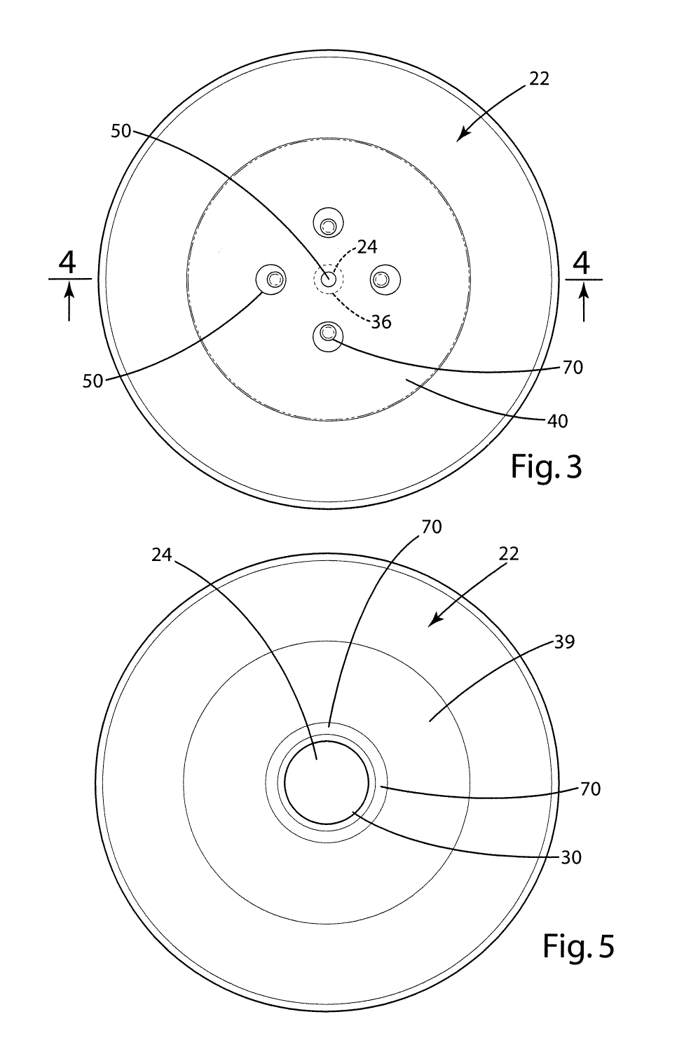

As illustrated in FIGS. 2 and 3, the dispersion end 22 of the nozzle 20 may include a set of depressions 70. The depressions 70, as illustrated in FIG. 2, on the dispersion end 22 are configured within the recessed area 39 to be aligned with the exit cavities. Therefore, a metering plate as illustrated in FIG. 1, having exit cavities 50 within the cavity axis 52, will have the metering plate lined up such that the cavity axis 52 will pass through or intersect the dispersion end 22 approximately within the bounds of one of the depressions 70. In each of the embodiments, the depressions appear under each exit cavity 50 due to the location or orientation of the fuel injector within the engine as the dispersion end 22 may not experience build-up and therefore not need the depressions 70 for consistent high performance. Some exit cavities experience build up, while other exit cavities may not experience build-up. Therefore, in some embodiments, the depressions 70 may be configured to only be located under exist cavities that do experience build-up. As illustrated in FIGS. 1-3, the center exit cavity is located approximately above the outlet passage 24 and therefore the cavity axis 52 for the center exit cavity 50 is substantially aligned with the longitudinal axis 15 and passes through the planar surface of the recessed area 39 on the dispersion end 22 at the outlet passage area.

The depressions 70 may also be formed with a sharp edge 71 which increases fluid turbulence within the orifice cavity 42. Any increase of fluid turbulence also helps to prevent build-up of deposits in the orifice cavity 42, and in particular against the dispersion end 22 of the nozzle 20. The increase in fluid turbulence also helps to improve atomization of the fuel as it leaves the metering plate. Improved atomization improves engine performance and fuel economy.

As further illustrated in FIGS. 5-7, a metering plate as illustrated in FIG. 6 may include a multitude of exit orifices 50. Each of these exit orifices 50 could be configured to have an individual depression underneath, however, for ease of manufacture, it may be desirable to provide a depression in an arcuate shape that follows the arcuate shape of the exit cavities 50. Therefore, as illustrated in FIG. 7, the exit cavities 50 on the metering plate 40 are shown and illustrated as lining up substantially over the depression 70 on the dispersion end 22. As further illustrated in FIG. 8, other configurations such as having two rings of exit cavities on the metering plate may be used. In these particular embodiments, in addition to the potential for individual depressions arranged under each exit cavity, it may be desirable to provide an inner and outer ring of depressions 70.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A fuel injector for delivering fuel to a cylinder of an engine, the fuel injector comprising:
a nozzle having a longitudinal axis and a valve passage extending along said longitudinal axis, said nozzle including a dispersion end;
a metering plate coupled to said dispersion end, said metering plate including at least one exit cavity having a cavity axis; and
an outlet cavity defined by said dispersion end and said metering plate and wherein said dispersion end further includes at least one depression and wherein said cavity axis approximately intersects with said dispersion end within said depression.

2. The fuel injector of claim 1 wherein said depression is an arcuate groove.

3. The fuel injector of claim 2 wherein said metering plate includes a second exit cavity having a cavity axis and wherein both of said first and second cavity axes terminate approximately within said arcuate groove.

4. The fuel injector of claim 1 wherein said depression is an elliptical shape.

5. The fuel injector of claim 1 wherein said depression is a circular shape.

6. The fuel injector of claim 1 wherein said depression is a radial shape centered approximately about said longitudinal axis and having a first radius.

7. The fuel injector of claim 6 including a second depression in a radial shape centered approximately about said longitudinal axis and having a second radius.

8. The fuel injector of claim 1 wherein said depression forms a portion of said outlet cavity.

9. The fuel injector of claim 1 wherein said metering plate includes a plurality of cavities each having a cavity axis and wherein each cavity axis intersects with said dispersion end within a depression.

10. The fuel injector of claim 1 wherein said dispersion end defines a valve outlet and wherein said metering plate includes a plurality of cavities each having a cavity axis and wherein each cavity axis intersects with said dispersion end within said depressions and said valve outlet.

11. A fuel injector for delivering fuel to a cylinder of an engine, the fuel injector comprising:
a nozzle having a longitudinal axis and a valve passage extending along said longitudinal axis, said nozzle including a dispersion end;
a metering plate coupled to said dispersion end, said metering plate including at least one exit cavity having a cavity axis and wherein said longitudinal axis does not pass through said one exit cavity; and
an outlet cavity defined by said dispersion end and said metering plate and wherein said dispersion end further includes at least one depression and wherein said cavity axis is aligned with said depression on said dispersion end.

12. The fuel injector of claim 11 wherein said metering plate includes a plurality of exit cavities and said nozzle defines a valve outlet and wherein the cavity axis for each of the exit cavities intersects with either a depression or said valve outlet.

13. The fuel injector of claim 11 wherein said outlet cavity is at least partially defined by said depressions.

14. A fuel injector for delivering fuel to a cylinder of an engine, the fuel injector comprising:
a nozzle having a longitudinal axis and a passage extending along said longitudinal axis, said nozzle including a dispersion end defining a recess, said dispersion end defining a valve outlet where said passage intersects with said dispersion end and wherein said dispersion end further includes at least two depressions arranged within said recess and arranged about said longitudinal axis.

15. A fuel injector comprising:
a nozzle having a longitudinal axis and a passage extending along said longitudinal axis, said nozzle including a dispersion end defining a recess, said dispersion end defining a valve outlet where said passage intersects with said dispersion end and wherein said dispersion end further includes at least one depressions arranged within said recess and arranged about said longitudinal axis, said depression having a sharp edge configured to increase fluid turbulence.

16. The fuel injector of claim 15 wherein said depression is a partial polygonal shape in cross section.

17. The fuel injector of claim 15 wherein said depression has an arcuate shape in cross section.
